(19) United States
(12) Patent Application Publication
(10) Pub. No.: US 2024/0362809 A1
(43) Pub. Date: Oct. 31, 2024

(54) IMAGE PROCESSING DEVICE AND IMAGE PROCESSING METHOD

(71) Applicant: Panasonic Intellectual Property Management Co., Ltd., Osaka (JP)

(72) Inventors: Masanori ERA, Kumamoto (JP); Masaharu FUKAKUSA, Kumamoto (JP)

(21) Appl. No.: 18/768,259

(22) Filed: Jul. 10, 2024

Related U.S. Application Data
(63) Continuation of application No. PCT/JP2022/046714, filed on Dec. 19, 2022.

(30) Foreign Application Priority Data
Jan. 14, 2022 (JP) 2022-004116

(51) Int. Cl. G06T 7/593; H04N 13/00; H04N 13/239

(52) U.S. Cl. CPC G06T 7/593; G06T 2207/10012; H04N 2013/0081; H04N 13/239

(57) ABSTRACT

An image processing device includes a measurement part configured to process a first image outputted from a first imaging part and a second image outputted from a second imaging part placed so as to be separated from the first imaging part, and search for a pixel block corresponding to a target pixel block on the first image, in a search range defined on the second image. The search range extends in a direction of separation between the first imaging part and the second imaging part. The measurement part executes a plurality of search processes for which search start positions and search end positions are different from each other, for the search range.

### CROSS REFERENCE TO RELATED APPLICATION

This application is a continuation of International Application No. PCT/JP2022/046714 filed on Dec. 19, 2022, entitled “IMAGE PROCESSING DEVICE AND IMAGE PROCESSING METHOD”, which claims priority under 35 U.S.C. Section 119 of Japanese Patent Application No. 2022-004116 filed on Jan. 14, 2022, entitled “IMAGE PROCESSING DEVICE AND IMAGE PROCESSING METHOD”. The disclosures of the above applications are incorporated herein by reference.

### BACKGROUND OF THE INVENTION

### Field of the Invention

The present invention relates to an image processing device and an image processing method for processing images acquired by a stereo camera.

### Description of Related Art

To date, an image processing device for processing images acquired by a stereo camera has been known. In this device, a parallax is detected from an image captured by each camera. A pixel block having a highest correlation with a target pixel block on one image (standard image) is searched for on another image (reference image). The search range is set in the direction of separation between the cameras with a position that is the same as that of the target pixel block, as a standard position. The pixel deviation amount of the pixel block extracted by the search, with respect to the standard position, is detected as the parallax. The distance to an object is calculated from this parallax by a triangulation method. Japanese Laid-Open Patent Publication No. 2013-206451 describes this type of image processing method.

In the above search method, if the object is closer to the cameras, the parallax becomes larger. Therefore, the search range set on the reference image becomes wider, so that the time required for search becomes longer.

### SUMMARY OF THE INVENTION

A first aspect of the present invention is directed to an image processing device. The image processing device according to the this aspect includes a measurement part configured to process a first image outputted from a first imaging part and a second image outputted from a second imaging part placed so as to be separated from the first imaging part, and search for a pixel block corresponding to a target pixel block on the first image, in a search range defined on the second image. The search range extends in a direction of separation between the first imaging part and the second imaging part. The measurement part respectively executes a plurality of search processes for a plurality of ranges into which the search range is divided.

In the image processing device according to the this aspect, the search range is divided into a plurality of ranges, and the plurality of search processes are executed for the plurality of divided ranges, respectively. Accordingly, the time required to search the search range can be shorter than when the search is continuously performed for the entire search range. Therefore, the search for the target pixel block can be performed at a higher speed.

A second aspect of the present invention is directed to an image processing method. The image processing method according to this aspect includes a step of processing a first image outputted from a first imaging part and a second image outputted from a second imaging part placed so as to be separated from the first imaging part, and searching for a pixel block corresponding to a target pixel block on the first image, in a search range defined on the second image. The search range extends in a direction of separation between the first imaging part and the second imaging part. The searching step includes a step of respectively executing a plurality of search processes for a plurality of ranges into which the search range is divided.

In the image processing method according to the this aspect, the same processes as in the first aspect are performed. Therefore, the same effects as those of the above first aspect are achieved.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a diagram showing a configuration of a stereo camera system according to an embodiment;

FIG. 2A and FIG. 2B are each a diagram schematically showing a method for setting a pixel block for a first image according to the embodiment;

FIG. 3A is a diagram schematically showing a state where a target pixel block is set on the first image according to the embodiment;

FIG. 3B is a diagram schematically showing a search range set on a second image for searching for the target pixel block in FIG. 3A according to the embodiment;

FIG. 4 is a diagram showing a method for setting search start positions and search end positions for a first process and a second process according to the embodiment;

FIG. 5 is a diagram showing a method for setting search start positions and search end positions for the first process and the second process according to the embodiment;

FIG. 6 is a flowchart showing a search process for a matching pixel block according to the embodiment;

FIG. 7A to FIG. 7D are each a diagram schematically showing the search process according to the embodiment;

FIG. 8 is a flowchart showing an extraction process for a pixel block corresponding to the target pixel block according to the embodiment;

FIG. 9A is a graph schematically showing a correlation value at each search position calculated in the first process according to the embodiment;

FIG. 9B is a graph schematically showing a correlation value at each search position calculated in the second process according to the embodiment;

FIG. 10A is a flowchart showing a process of calculating the distance to an object according to the embodiment;

FIG. 10B is a diagram schematically showing a method for acquiring a pixel deviation amount according to the embodiment;

FIG. 11A and FIG. 11B are each a diagram schematically showing an example of the use form of the stereo camera system according to the embodiment;

FIG. 12 is a flowchart showing an extraction process for a pixel block corresponding to a target pixel block according to Modification 1;

FIG. 13A is a graph schematically showing a correlation value at each search position calculated in a first process according to Modification 1;

FIG. 13B is a graph schematically showing a correlation value at each search position calculated in a second process according to Modification 1;

FIG. 14 is a flowchart showing an extraction process for a pixel block corresponding to a target pixel block according to Modification 2;

FIG. 15A is a graph schematically showing a correlation value at each search position calculated in a first process according to Modification 2;

FIG. 15B is a graph schematically showing a correlation value at each search position calculated in a second process according to Modification 2;

FIG. 16A is a diagram showing a method for setting target pixel blocks according to Modification 3;

FIG. 16B is a diagram showing a method for setting a search area according to Modification 3;

FIG. 17A is a diagram showing the method for setting the target pixel blocks according to Modification 3;

FIG. 17B is a diagram showing the method for setting the search area according to Modification 3;

FIG. 18A to FIG. 18C are each a diagram schematically showing a search process for the search area according to Modification 3; and

FIG. 19 is a flowchart showing an extraction process for a matching pixel block according to Modification 3.

It is noted that the drawings are solely for description and do not limit the scope of the present invention in any way.

### DETAILED DESCRIPTION

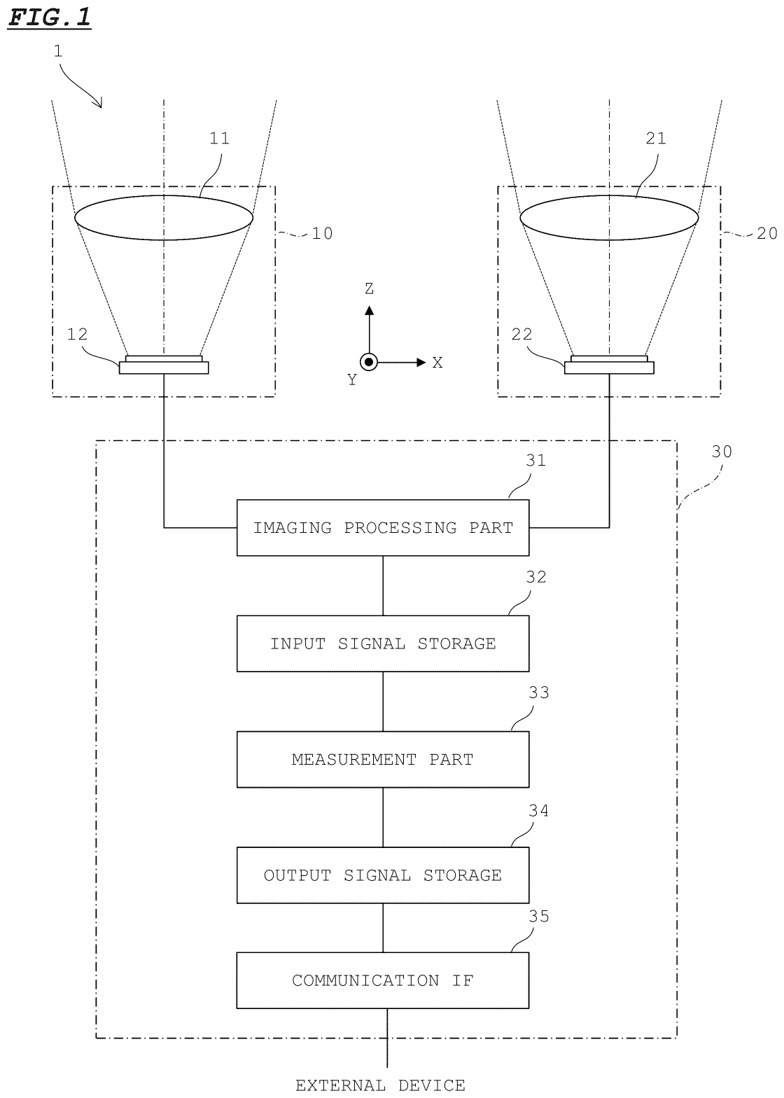

Hereinafter, an embodiment of the present invention will be described with reference to the drawings. For convenience, in FIG. 1, X, Y, and Z axes that are orthogonal to each other are additionally shown. The X-axis direction is the direction of separation between a first imaging part and a second imaging part, and the Z-axis positive direction is the imaging direction of each imaging part.

FIG. 1 is a diagram showing a configuration of a stereo camera system 1.

The stereo camera system 1 includes a first imaging part 10, a second imaging part 20, and an image processing device 30.

The first imaging part 10 includes an imaging lens 11 and an imaging element 12. The imaging lens 11 condenses light from an imaging area, onto a light-receiving surface of the imaging element 12. The imaging element 12 is a CMOS image sensor. The imaging element 12 may be a CCD.

The second imaging part 20 has the same configuration as the first imaging part 10. The second imaging part 20 includes an imaging lens 21 and an imaging element 22. The imaging lens 21 condenses light from an imaging area, onto a light-receiving surface of the imaging element 22. The imaging element 22 is a CMOS image sensor. The imaging element 22 may be a CCD.

The first imaging part 10 and the second imaging part 20 are placed at the same position as each other in the Y-axis direction and the Z-axis direction, and are separated from each other in the X-axis direction. The imaging directions of the first imaging part 10 and the second imaging part 20 are the Z-axis positive direction. That is, the optical axes of the imaging lenses 11 and 21 are parallel to the Z axis. The imaging area of the first imaging part 10 and the imaging area of the second imaging part 20 overlap each other.

The image processing device 30 includes a circuit board on which a semiconductor integrated circuit composed of an FPGA (Field Programmable Gate Array) is mounted. In the semiconductor integrated circuit, an imaging processing part 31, an input signal storage 32, a measurement part 33, an output signal storage 34, and a communication interface 35 are arranged. Each of these parts executes processing corresponding to the logic circuit design set in the FPGA. The image processing device 30 may include other semiconductor integrated circuits such as a DSP (Digital Signal Processor), a GPU (Graphics Processing Unit), and an ASIC (Application Specific Integrated Circuit), or may include a microcomputer.

The imaging processing part 31 controls the imaging elements 12 and 22, performs processing such as luminance correction and camera calibration on a pixel signal of each pixel on the imaging element 12 and a pixel signal of each pixel on the imaging element 22, and stores stereo image signals resulting from the processing, in the input signal storage 32.

A first image outputted from the first imaging part 10 and processed by the imaging processing part 31 and a second image outputted from the second imaging part 20 and processed by the imaging processing part 31 are stored in the input signal storage 32.

The measurement part 33 includes two processing circuits that execute a first process and a second process described later, respectively. The measurement part 33 acquires the distance to an object projected on each pixel block on the first image, by comparing and processing the above-described first image and second image and performing a stereo correspondence point search. The acquired distance information is stored in the output signal storage 34 in association with each pixel block.

That is, the measurement part 33 sets a pixel block to be the target for distance acquisition (hereinafter referred to as “target pixel block”) on the first image, and searches for a pixel block corresponding to the target pixel block, that is, a pixel block that best matches the target pixel block (hereinafter referred to as “matching pixel block”), in a search range defined on the second image. Then, the measurement part 33 performs a process of acquiring a pixel deviation amount between a pixel block at the same position as the target pixel block on the second image (hereinafter referred to as “standard pixel block”) and the matching pixel block extracted from the second image by the above search, and calculating the distance to the object at the position of the target pixel block from the acquired pixel deviation amount. The distance signal stored in the output signal storage 34 is transmitted to an external device via the communication interface 35.

Hereinafter, the process by the measurement part 33 will be described.

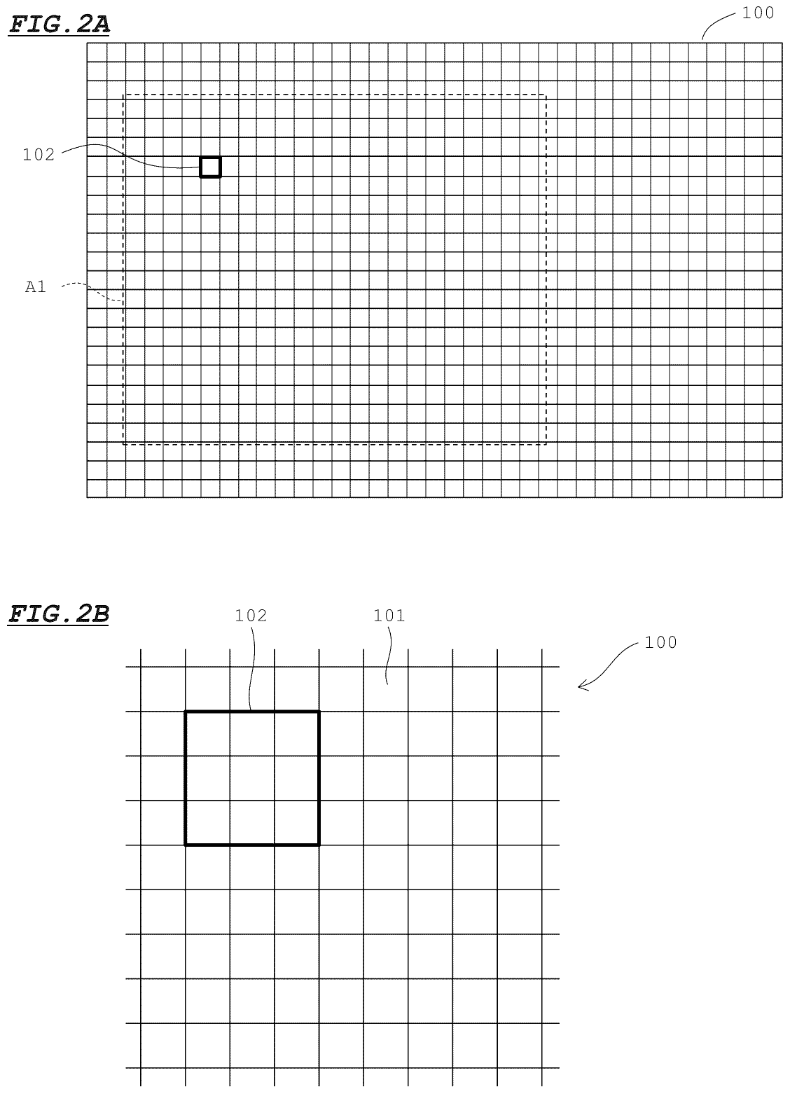

FIG. 2A and FIG. 2B are each a diagram schematically showing a method for setting a pixel block 102 for a first image 100. FIG. 2A shows a method for setting the pixel block 102 for the entire first image 100, and FIG. 2B shows a partial region of the first image 100 in an enlarged manner.

As shown in FIG. 2A and FIG. 2B, the first image 100 is divided into a plurality of pixel blocks 102 each including a predetermined number of pixel regions 101. Each pixel region 101 is a region corresponding to one pixel on the imaging element 12. That is, each pixel region 101 is a smallest unit of the first image 100. In the example in FIG. 2A and FIG. 2B, one pixel block 102 is composed of nine pixel regions 101 arranged in three rows and three columns. However, the number of pixel regions 101 included in one pixel block 102 is not limited thereto.

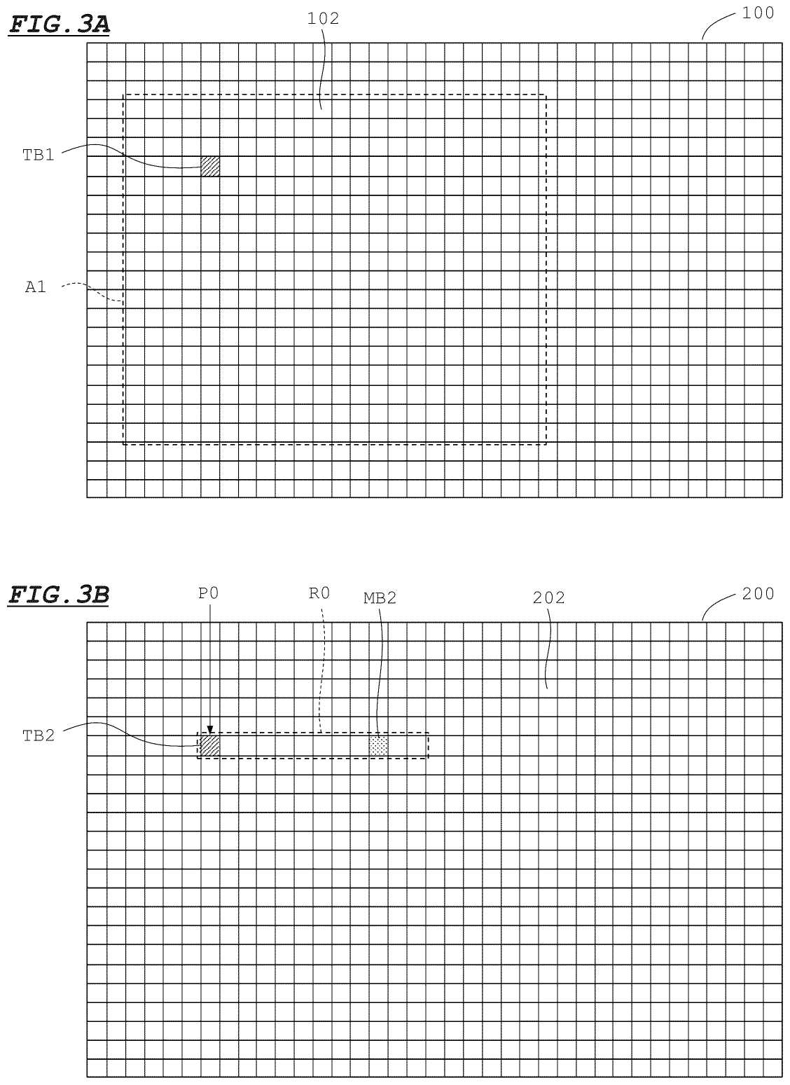

FIG. 3A is a diagram schematically showing a state where a target pixel block TB1 is set on the first image 100, and FIG. 3B is a diagram schematically showing a search range R0 set on a second image 200 in order to search for the target pixel block in FIG. 3A.

In FIG. 3B, for convenience, similar to the first image 100, the second image 200 acquired from the second imaging part 20 is divided into a plurality of pixel blocks 202. Each pixel block 202 includes pixel regions whose number is the same as in the pixel blocks 102 described above.

In FIG. 3A, the target pixel block TB1 is a pixel block 102 to be processed among the pixel blocks 102 included in a detection region A1. In addition, in FIG. 3B, a standard pixel block TB2 is the pixel block 202, on the second image 200, at the same position as the target pixel block TB1.

The measurement part 33 reads the first image 100 and the second image 200 captured at the same timing, from the input signal storage 32, and processes these images. The measurement part 33 identifies the standard pixel block TB2 at the same position as the target pixel block TB1, on the second image 200. Then, the measurement part 33 sets the position of the identified standard pixel block TB2 as a standard position P0 of the search range R0, and sets a range extending from the standard position P0 in the direction of separation between the first imaging part 10 and the second imaging part 20, as the search range R0.

The direction in which the search range R0 extends is set to a direction in which a pixel block (matching pixel block MB2) corresponding to the target pixel block TB1 deviates from the standard position P0 on the second image 200 due to a parallax. Here, the search range R0 is set by 12 pixel blocks 202 aligned in the right direction (direction corresponding to the X-axis direction in FIG. 1) from the standard position P0. However, the number of pixel blocks 202 included in the search range R0 is not limited to this number. In addition, the starting point of the search range R0 is not limited to the standard pixel block TB2, and, for example, a position shifted from the standard pixel block TB2 in the right direction by several blocks may be set as the starting point of the search range R0.

The measurement part 33 searches for the pixel block (matching pixel block MB2) corresponding to the target pixel block TB1, in the search range R0 set as described above. Here, the measurement part 33 executes a plurality of search processes in parallel for a plurality of ranges into which the search range R0 is divided. In the present embodiment, the search range R0 is divided into two ranges, the first half and the second half, and the first process and the second process are executed in parallel for these two ranges.

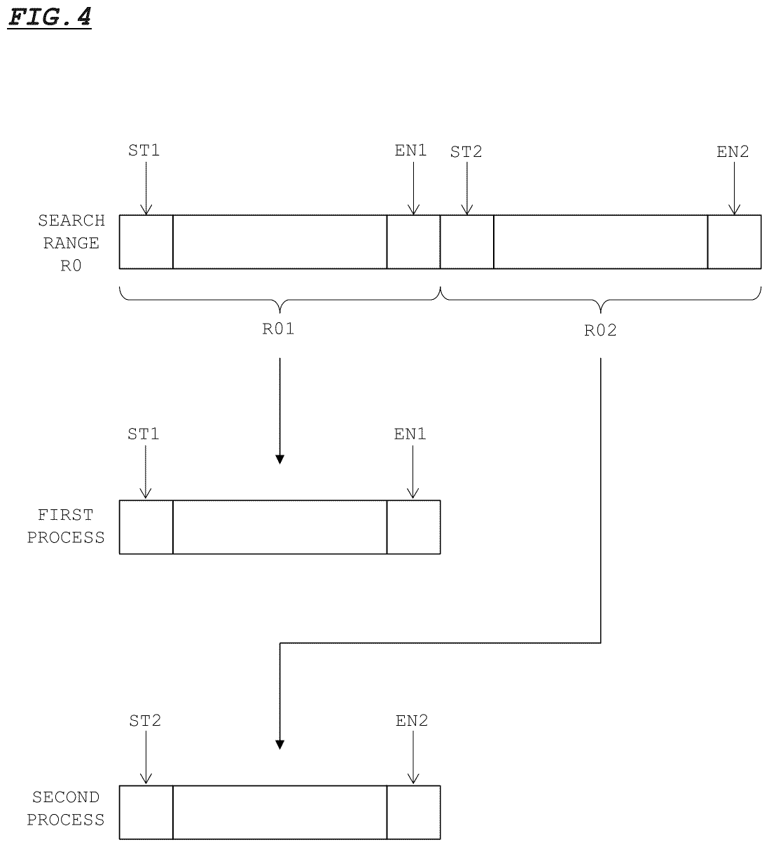

FIG. 4 is a diagram showing a method for setting search start positions and search end positions for the first process and the second process.

In this setting method, a search start position ST1 and a search end position EN1 for the first process and a search start position ST2 and a search end position EN2 for the second process are set in the search range R0 such that the search range R0 is divided into the first half and the second half. Accordingly, the search range R0 is divided into a first search range R01 and a second search range R02.

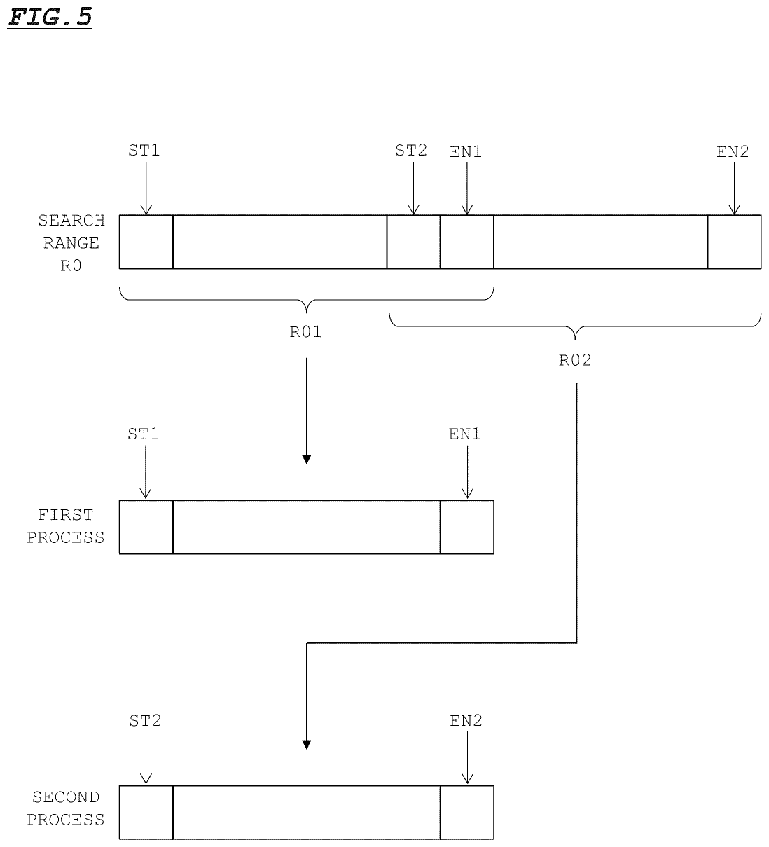

FIG. 5 is a diagram showing another method for setting search start positions and search end positions for the first process and the second process.

In this setting method, a first search range R01 and a second search range R02 overlap partially. Here, two pixel blocks at the end of the first search range R01 and two pixel blocks at the beginning of the second search range R02 overlap. Therefore, each of the first search range R01 and the second search range R02 is longer by one pixel block than in the case of FIG. 4. However, in this setting method, the number of pixel blocks by which the first search range R01 and the second search range R02 overlap is not limited thereto.

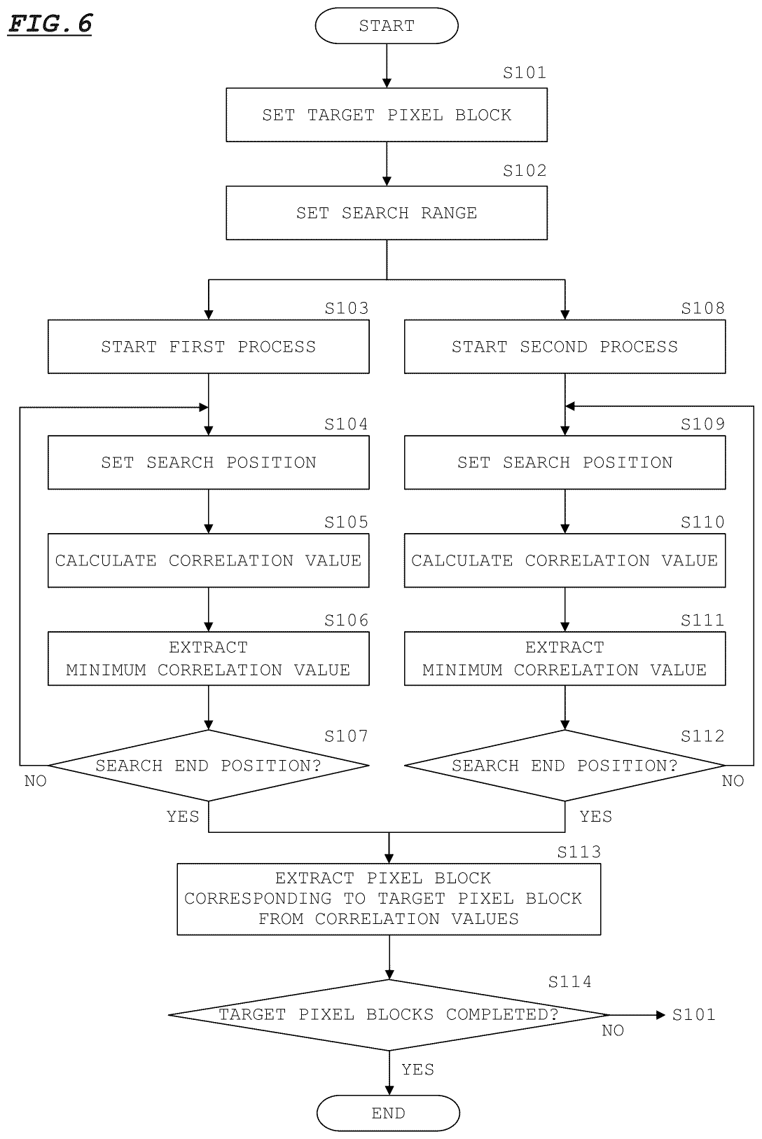

FIG. 6 is a flowchart showing a search process for the matching pixel block MB2. FIG. 6 shows a process for the first image 100 and the second image 200 acquired at the same timing.

The measurement part 33 sets one of the pixel blocks 102 included in the detection region A1 on the first image 100, as the target pixel block TB1 (S101). For example, the pixel block 102 at the upper left corner on the detection region A1 in FIG. 3A is set as the target pixel block TB1. Next, the measurement part 33 sets the search range R0 for the target pixel block TB1 on the second image 200 by the method described above (S102). Then, the measurement part 33 executes the first process (S103 to S107) and the second process (S108 to S112) described above in parallel for the set search range R0.

That is, the measurement part 33 sets the search start position ST1 and the search end position EN1 by the method shown in FIG. 4 or FIG. 5, and starts the first process (S103). In the first process, the measurement part 33 sets a search position in the first search range R01 defined by the search start position ST1 and the search end position EN1 (S104), and calculates a correlation value between the pixel block at this search position and the target pixel block TB1 (S105). Then, the measurement part 33 compares the correlation value calculated this time with the minimum correlation value calculated up to that time. If the correlation value calculated this time is lower than the minimum correlation value up to that time, the measurement part 33 sets the correlation value this time as the minimum correlation value (S106). The measurement part 33 executes the above process for all search positions that can be set on the first search range R01 (S107).

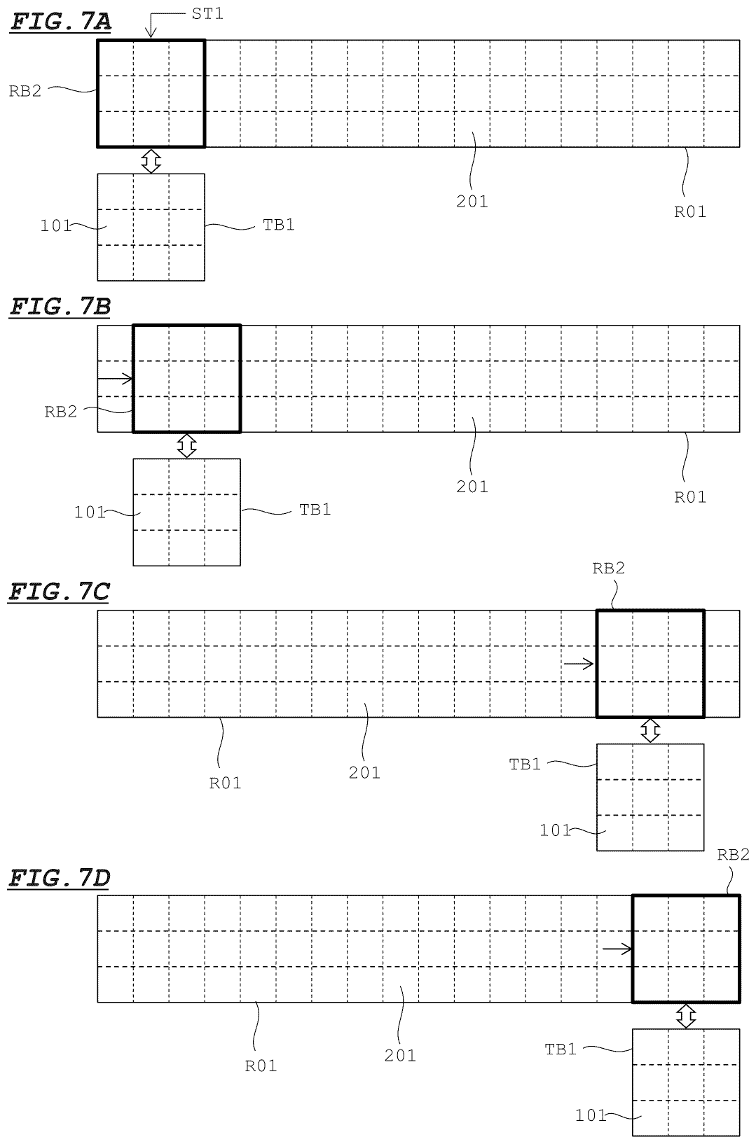

FIG. 7A to FIG. 7D are each a diagram schematically showing the process in steps S104 to S107 in FIG. 6.

First, as shown in FIG. 7A, the measurement part 33 sets the search start position ST1 of the first search range R01 as a search position (FIG. 6: S104). Next, the measurement part 33 sets a reference pixel block RB2 having the same size as the target pixel block TB1, at this search position, and calculates a correlation value between the target pixel block TB1 and the reference pixel block RB2 (FIG. 6: S105).

Here, the correlation value is acquired, for example, as a value (SAD) obtained by calculating the differences between the pixel values (luminance) for the mutually corresponding pixel regions 101 and 201 in the target pixel block TB1 and the reference pixel block RB2 and integrating all the absolute values of the respective calculated differences. Alternatively, the correlation value may be acquired as a value (SSD) obtained by integrating all the squared values of the above differences. However, the calculation method for the correlation value is not limited to these methods, and other calculation methods may be used as long as the correlation between the target pixel block TB1 and the reference pixel block RB2 is indexed.

If the calculated correlation value is lower than the minimum correlation value up to that time, the measurement part 33 sets the correlation value this time as the minimum correlation value (FIG. 6: S106). In the case of FIG. 7A, since the correlation value is calculated for the first time, the calculated correlation value is set as the minimum correlation value.

Then, when the process for one reference pixel block RB2 is completed, the measurement part 33 sets the next search position as shown in FIG. 7B (FIG. 6: S104). Specifically, the measurement part 33 sets a position shifted from the last search position in the direction to the end of the first search range R01 by one pixel, as a search position this time. Then, the measurement part 33 calculates a correlation value between the reference pixel block RB2 at the search position this time and the target pixel block TB1 by the same process as above (FIG. 6: S105). If the calculated correlation value is lower than the minimum correlation value up to that time, the measurement part 33 sets the correlation value this time as the minimum correlation value (FIG. 6: S106). In this case, the measurement part 33 sets the search position this time as the search position at which the minimum correlation value has been acquired.

The measurement part 33 repeats the same process while shifting the search position in the direction to the end by one pixel. FIG. 7C shows a state where the reference pixel block RB2 is set at the search position immediately before the final search position in the first search range R01, and FIG. 7D shows a state where the reference pixel block RB2 is set at the final search position in the first search range R01. Then, when the process for the final search position is completed, the determination in step S107 in FIG. 6 becomes YES, and the first process ends. Accordingly, the measurement part 33 acquires the search position at which the correlation value is minimum, among the search positions set sequentially in the first process, and this correlation value.

Referring back to FIG. 6, the second process in steps S108 to S112 is also performed in the same manner as the first process described above. In this case, the measurement part 33 executes the same process as FIG. 7A to FIG. 7D for the second search range R02 set for the second process. Accordingly, the measurement part 33 acquires the search position at which the correlation value is minimum, among the search positions set sequentially in the second process, and this correlation value. Then, after the first process and the second process are performed in parallel, the measurement part 33 extracts the reference pixel block RB2 (matching pixel block MB2) corresponding to the target pixel block TB1, from the correlation values acquired by the first process and the second process (S113).

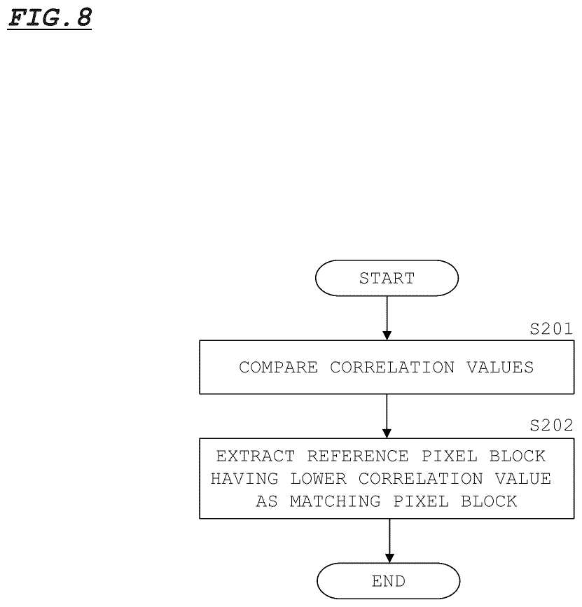

FIG. 8 is a flowchart showing the extraction process for the matching pixel block MB2 corresponding to the target pixel block TB1 in step S113 in FIG. 6.

The measurement part 33 compares the minimum correlation values acquired by the first process and the second process, respectively (S201). Then, the measurement part 33 extracts the reference pixel block RB2 at the search position at which the lower one of these two correlation values has been acquired, as the pixel block (matching pixel block MB2) corresponding to the target pixel block TB1 (S202).

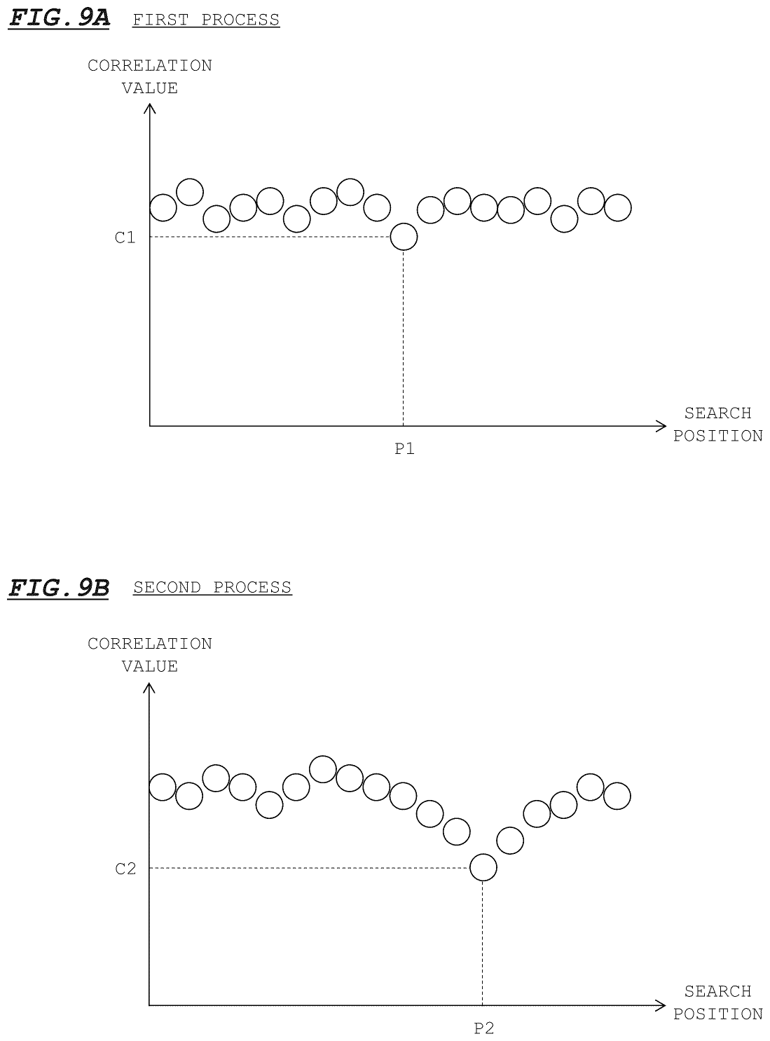

FIG. 9A is a graph schematically showing the correlation value at each search position calculated in the first process. FIG. 9B is a graph schematically showing the correlation value at each search position calculated in the second process.

In the example in FIG. 9A and FIG. 9B, a correlation value C1 at a search position P1 is the minimum value in the first process, and a correlation value C2 at a search position P2 is the minimum value in the second process. Here, the correlation value C2 is lower than the correlation value C1. Therefore, in this example, the reference pixel block RB2 at the search position P2 at which the correlation value C2 is acquired in the second process is extracted as the matching pixel block MB2 corresponding to the target pixel block TB1.

Referring back to FIG. 6, then, when the matching pixel block MB2 corresponding to the target pixel block TB1 is extracted (S113), the measurement part 33 determines whether or not the process has been completed for all the pixel blocks 102 in the detection region A1 (S114). If the process has not been completed for all the pixels block 102 (S114: NO), the measurement part 33 returns the process to step S101, sets the next target pixel block TB1 from the pixel blocks in the detection region A1, and executes the process from step S102. Accordingly, the matching pixel block MB2 corresponding to the next target pixel block TB1 is extracted from the second image 200 (S113).

The measurement part 33 repeats the same process until the process is completed for all the pixel blocks 102 in the detection region A1. Accordingly, the matching pixel blocks MB2 corresponding to all the pixel blocks 102 in the detection region A1 are extracted from the second image 200 (S113). Then, when the process has been completed for all the pixel blocks 102 in the detection region A1 (S114: YES), the measurement part 33 ends the process in FIG. 6.

Next, the measurement part 33 executes a process of calculating the distance to an object for each pixel block 102 in the detection region A1.

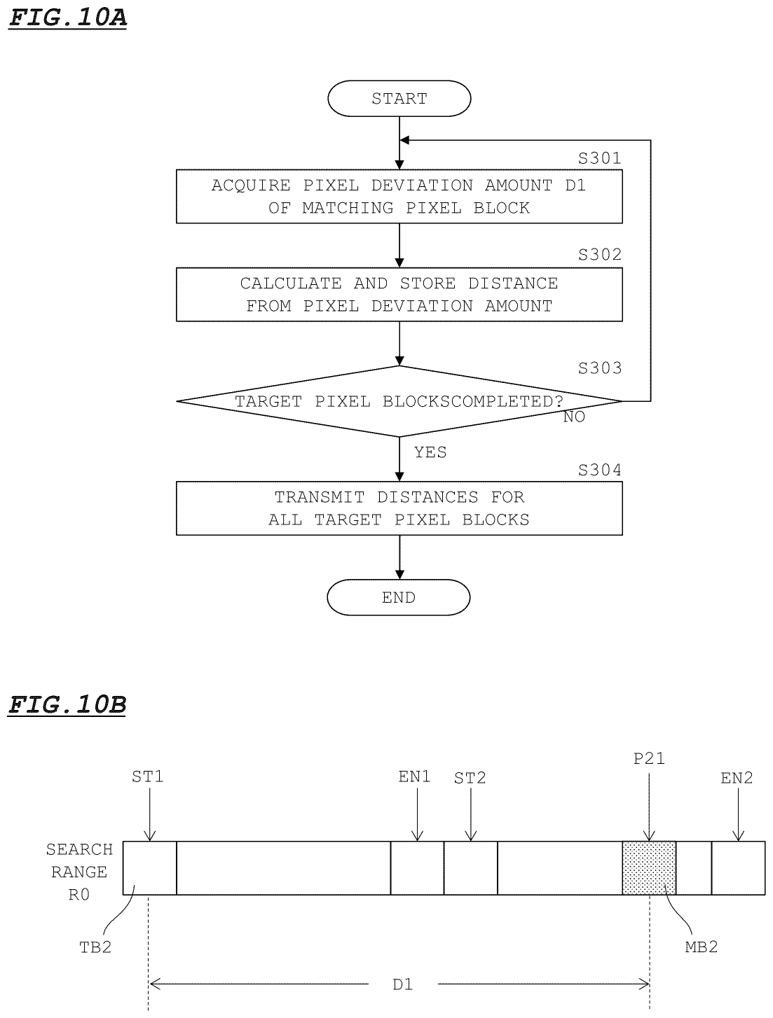

FIG. 10A is a flowchart showing the process of calculating the distance to the object.

First, the measurement part 33 selects one pixel block 102 from among all the pixel blocks 102 (target pixel blocks TB1) included in the detection region A1, and acquires a pixel deviation amount D1 of the matching pixel block MB2 extracted by the process in FIG. 6 as corresponding to this pixel block 102 (S301). Specifically, as shown in FIG. 10B, if the search position for the matching pixel block MB2 is a position P21, the pixel deviation amount D1 between the standard pixel block TB2 (the pixel block at the search start position ST1) on the second image 200 at the same position as the selected pixel block 102 and the matching pixel block MB2 at the position P21 is acquired in step S301.

Next, the measurement part 33 calculates a distance by a triangulation method from the pixel deviation amount D1 and the separation distance between the first imaging part 10 and the second imaging part 20. The distance calculated by the measurement part 33 is stored as the distance to the object in a direction corresponding to the selected pixel block, in the output signal storage 34 (S302).

The measurement part 33 repeats the same process for all the pixel blocks 102 (target pixel blocks TB1) included in the detection region A1 (S303). Then, when the distances are acquired for all the pixel blocks 102 (target pixel blocks TB1) included in the detection region A1 (S303: YES), the distances stored in the output signal storage 34 are transmitted to an external device via the communication interface 35 (S304).

Then, the measurement part 33 ends the process for the first image 100 and the second image 200 acquired at the same timing. The measurement part 33 sequentially performs the process for the first images 100 and the second images 200 acquired at subsequent timings, and the distances acquired for all the pixel blocks 102 included in the detection region A1 are transmitted to the external device via the communication interface 35.

The process in FIG. 10A may be performed between step S113 and step S114 in FIG. 6. That is, when a matching pixel block MB2 is extracted in step S113, a pixel deviation amount D1 between this matching pixel block MB2 and a standard pixel block TB2 set in the extraction of this matching pixel block MB2 may be acquired, and the distance based on the pixel deviation amount D1 may be calculated. In this case, as a result of completing the process in FIG. 6, the distances for all the target pixel blocks TB1 are acquired.

Alternatively, the output signal may be stored in the output signal storage 34 as a parallax signal instead of the distance, and may be transmitted to the external device via the communication interface 35. In this case, the external device performs a process of converting the received parallax signal into a distance signal. The signal stored in the output signal storage 34 and transmitted to the external device may be any signal from which the distance to the object to be imaged can be obtained.

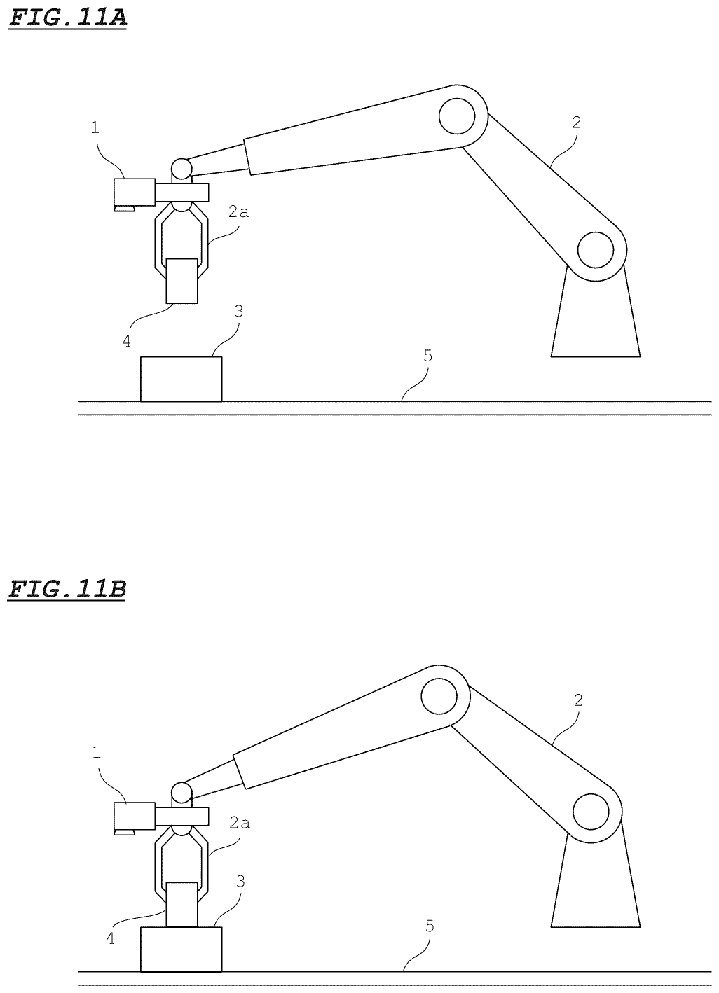

FIG. 11A and FIG. 11B are each a diagram schematically showing an example of the use form of the stereo camera system 1.

In this use form, the stereo camera system 1 is installed near a gripping portion 2a of a robot arm 2. The robot arm 2 places an item 4 onto a container 3 located on a belt conveyor 5. The stereo camera system 1 transmits the distances acquired for all the target pixel blocks TB1 by the above process, to a controller (external device) on the robot arm 2 side in step S304 in FIG. 10A. The controller on the robot arm 2 side determines the position of the container 3 and the distance to the container 3, based on the received distance for each target pixel block TB1, and controls the robot arm 2 such that the item 4 is placed on the container 3. Accordingly, the robot arm 2 can smoothly place the item 4 onto the container 3 as shown in FIG. 11B.

### Effects of Embodiment

According to the above embodiment, the following effects are achieved.

As shown in FIG. 4 and FIG. 5, the search range R0 is divided into a plurality of ranges (first search range R01 and second search range R02), and a plurality of search processes (first process and second process) are executed for the plurality of divided ranges, respectively. Accordingly, the time required to search the search range R0 can be shorter than when the search is continuously performed for the entire search range R0. Therefore, the search for the target pixel block TB1 can be performed at a higher speed.

As shown in FIG. 6, the measurement part 33 performs a plurality of search processes, that is, the first process (S103 to S107) and the second process (S108 to S112), in parallel for the same search range R0. Accordingly, the time required to search the search range R0 can be significantly shorter than when the search is continuously performed for the entire search range R0. Therefore, the search for the target pixel block TB1 can be performed at a higher speed.

As shown in FIG. 8 and FIG. 9, based on the processing results of the plurality of search processes (first process and second process), the measurement part 33 extracts the reference pixel block RB2 having a highest degree of correlation with the target pixel block TB1 (reference pixel block RB2 having a minimum correlation value) as the pixel block (matching pixel block MB2) corresponding to the target pixel block TB1 (S202). Accordingly, the pixel block corresponding to the target pixel block TB1 can be appropriately extracted from the second image.

### Modification 1

In the above embodiment, as shown in FIG. 8, the reference pixel block RB2 at which the minimum correlation value (highest degree of correlation) has been acquired is extracted as the pixel block (matching pixel block MB2) corresponding to the target pixel block TB1. In contrast, in Modification 1, the reference pixel block RB2 whose degree of correlation with the target pixel block TB1 does not exceed a predetermined threshold value is excluded from the extraction target.

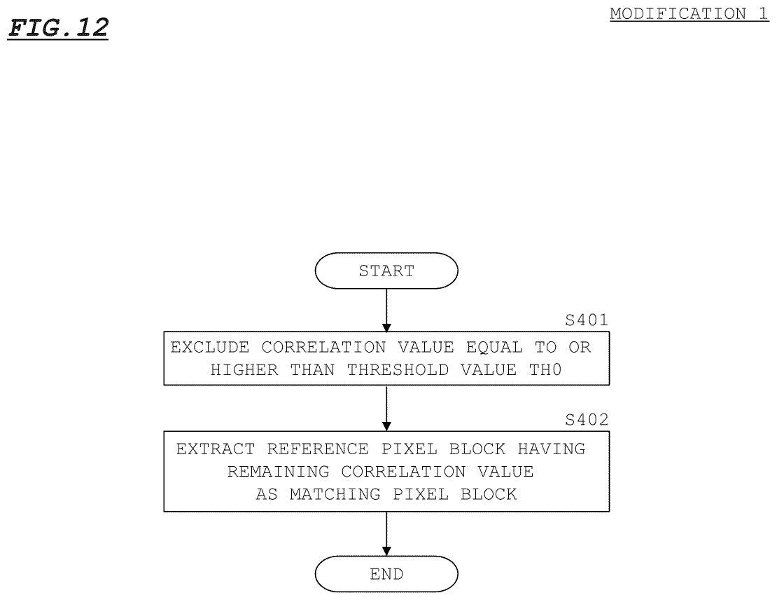

FIG. 12 is a flowchart showing an extraction process for the matching pixel block MB2 corresponding to the target pixel block TB1 according to Modification 1. This process is executed in step S113 in FIG. 6.

The measurement part 33 excludes, from the extraction target, the reference pixel block RB2 at which the correlation value equal to or higher than a threshold value Th0 has been acquired (the reference pixel block RB2 whose degree of correlation does not exceed the threshold value), out of the minimum correlation value acquired by the first process in steps S103 to S107 in FIG. 6 and the minimum correlation value acquired by the second process in steps S108 to S112 in FIG. 6 (S401). Then, the measurement part 33 extracts the reference pixel block RB2 at which the correlation value remaining without being excluded in step S401 has been acquired, as the pixel block (matching pixel block MB2) corresponding to the target pixel block (S402)

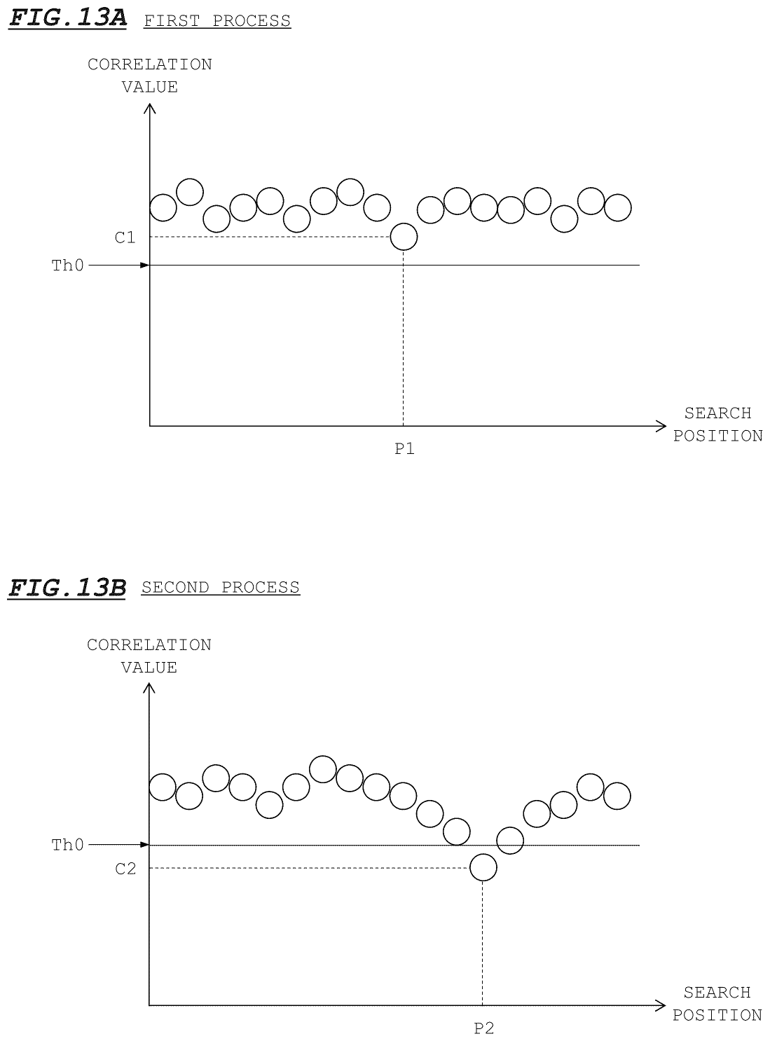

FIG. 13A is a graph schematically showing a correlation value at each search position calculated in the first process according to Modification 1. FIG. 13B is a graph schematically showing a correlation value at each search position calculated in the second process according to Modification 1.

In the example in FIG. 13A and FIG. 13B, a correlation value C1 at a search position P1 is the minimum value in the first process, and a correlation value C2 at a search position P2 is the minimum value in the second process. Here, the correlation value C1 is equal to or higher than the threshold value Th0, and the correlation value C2 is lower than threshold value Th0. Therefore, in this example, the reference pixel block RB2 at the search position P1 at which the correlation value C1 has been acquired in the first process is excluded from the extraction target, and the reference pixel block RB2 at the search position P2 at which the correlation value C2 has been acquired in the second process is extracted as the matching pixel block MB2 corresponding to the target pixel block TB1.

Here, the threshold value Th0 is set to a value with which the reference pixel block RB2 (matching pixel block MB2) corresponding to the target pixel block TB1 can be properly acquired in the measurement distance range by the process in FIG. 12. That is, if the threshold value Th0 is excessively high (if the degree of correlation at the threshold value Th0 is excessively low), the correlation values C1 and C2 acquired by the first process and the second process, respectively, both become lower than the threshold value Th, so that the reference pixel block RB2 (matching pixel block MB2) corresponding to the target pixel block TB1 cannot be properly acquired by the process in FIG. 12. On the other hand, if the threshold value Th0 is excessively low (if the degree of correlation at the threshold value Th0 is excessively high), the correlation values C1 and C2 acquired by the first process and the second process, respectively, both become equal to or higher than the threshold value Th0, so that the reference pixel block RB2 (matching pixel block MB2) corresponding to the target pixel block TB1 cannot be properly acquired by the process in FIG. 12.

Therefore, the threshold value Th0 is set such that only either one of the correlation values C1 and C2 acquired by the first process and the second process, respectively, remains without being excluded by the process in FIG. 12, and the reference pixel block RB2 at which the remaining correlation value has been acquired is the reference pixel block (matching pixel block MB2) at a proper pixel deviation position corresponding to the distance to the object. This setting can be made, for example, by checking whether or not the distance (matching pixel block MB2) for each target pixel block TB1 can be properly acquired while changing the threshold value Th0 in a state where the object is placed at a predetermined distance position in the measurement distance range.

According to Modification 1, the reference pixel block RB2 whose correlation value with the target pixel block TB1 is equal to or higher than the threshold value Th0 (pixel block whose degree of correlation does not exceed the predetermined threshold value) is excluded from the extraction target in the plurality of search processes (the first process and the second process), so that the reference pixel block RB2 corresponding to the target pixel block TB1 can be smoothly extracted from the second image 200.

If, in step S401 in FIG. 12, the correlation values acquired by the first process and the second process, respectively, both become lower than the threshold value, and both of the reference pixel blocks RB2 at which these correlation values have been acquired are not excluded, the reference pixel block RB2 at which the lower one of these correlation values has been acquired may be extracted as the reference pixel block RB2 corresponding to the target pixel block TB1.

In addition, if, in step S401 in FIG. 12, the correlation values acquired by the first process and the second process, respectively, both become equal to or higher than the threshold value, and both of the reference pixel blocks RB2 at which these correlation values have been acquired are excluded, the process may be performed with no reference pixel block RB2 corresponding to the target pixel block TB1 being extracted, or the reference pixel block RB2 at which the lower one of these correlation values has been acquired may be extracted as the reference pixel block RB2 corresponding to the target pixel block TB1.

### Modification 2

In the above embodiment, as shown in FIG. 8, the reference pixel block RB2 at which the minimum correlation value (highest degree of correlation) has been acquired is extracted as the pixel block (matching pixel block MB2) corresponding to the target pixel block TB1. In contrast, in Modification 2, the measurement part 33 acquires information about the distance to the object to be imaged from an external device via the communication interface 35, and selects a processing result to be the target for extraction of the matching pixel block MB2, based on the acquired information.

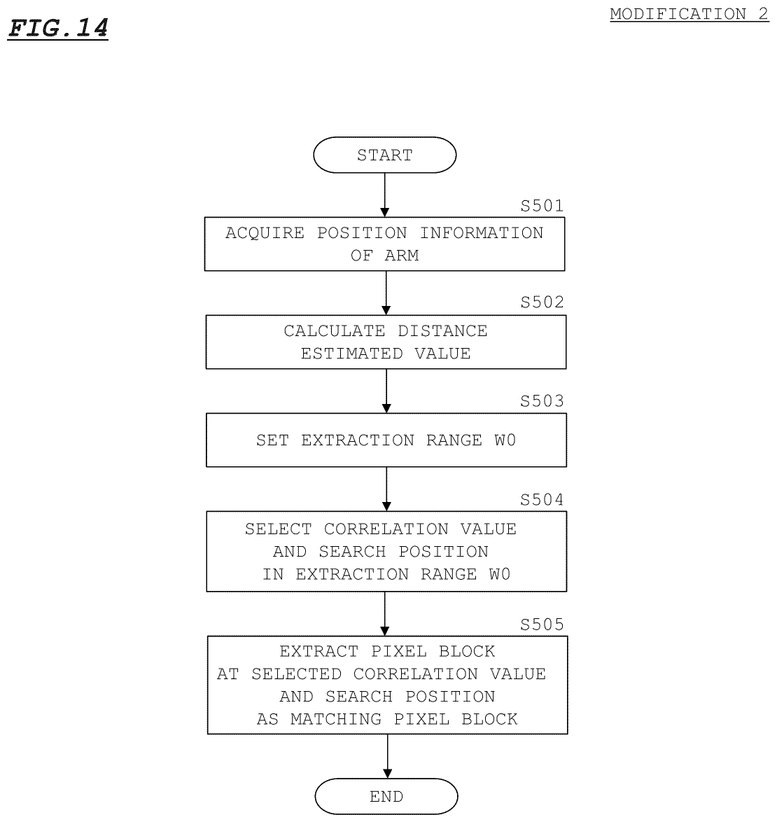

FIG. 14 is a flowchart showing an extraction process for the pixel block corresponding to the target pixel block TB1 according to Modification 2. This process is executed in step S113 in FIG. 6.

The measurement part 33 acquires control position information (3D position, rotation angle, rotation radius, etc.) of the gripping portion 2a of the robot arm 2 from the controller on the robot arm 2 side via the communication interface 35 (S501). The measurement part 33 calculates an estimated value of the distance to the container 3, based on the acquired control position information (S502), and sets a predetermined distance range centered at the calculated estimated value (range of possible variations to be estimated) as a search position extraction range W0 (S503). Then, the measurement part 33 selects a search position included in the extraction range W0 from among the search positions for the minimum correlation values acquired by the first process and the second process, respectively (S504), and extracts the reference pixel block RB2 at the selected search position as the matching pixel block MB2 (S505).

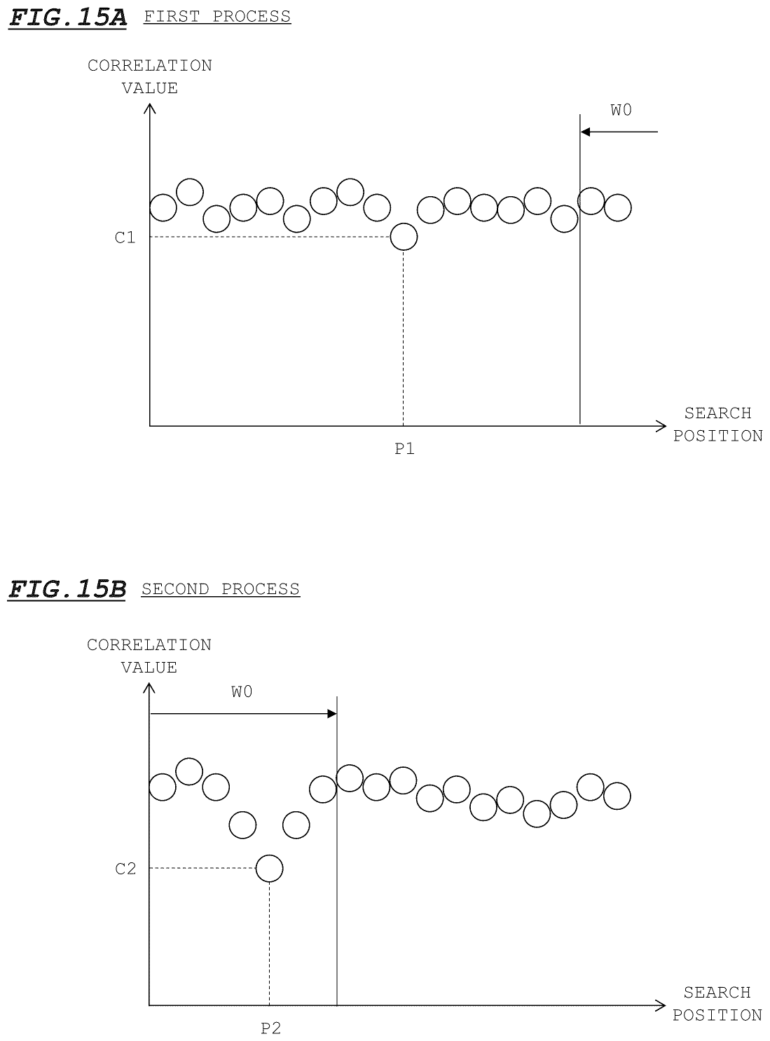

FIG. 15A is a graph schematically showing a correlation value at each search position calculated in the first process according to Modification 2. FIG. 15B is a graph schematically showing a correlation value at each search position calculated in the second process according to Modification 2.

In the example in FIG. 15A and FIG. 15B, a correlation value C1 at a search position P1 is the minimum value in the first process, and a correlation value C2 at a search position P2 is the minimum value in the second process. Here, the search position P1 for the correlation value C1 is not included in the extraction range W0, and the search position P2 for the correlation value C2 is included in the extraction range W0. Therefore, in this example, the reference pixel block RB2 at the search position P2 at which the correlation value C2 has been acquired in the second process is extracted as the matching pixel block MB2 corresponding to the target pixel block TB1.

According to Modification 2, the search position extraction range W0 is set based on the information about the distance to the object to be imaged (control position information of the gripping portion 2a), and the search position included in the extraction range W0, out of the search positions acquired by the first process and the second process, respectively, is selected as the search position for the matching pixel block MB2, so that the reference pixel block RB2 corresponding to the target pixel block TB1 can be properly and smoothly extracted from the second image 200.

If, in step S504 in FIG. 14, the search positions acquired by the first process and the second process, respectively, are both included in the extraction range W0, one of these search positions having a lower correlation value may be extracted as the search position for the reference pixel block RB2 corresponding to the target pixel block TB1.

In addition, if, in step S504 in FIG. 14, none of the search positions acquired by the first process and the second process, respectively, are included in the extraction range W0, the process may be performed with no reference pixel block RB2 corresponding to the target pixel block TB1 being extracted, or one of these search positions having a lower correlation value may be extracted as the search position for the reference pixel block RB2 corresponding to the target pixel block TB1.

In the process in FIG. 14, the control position information of the gripping portion 2a is acquired as information about the distance to the object to be imaged (S501), and the estimated value of the distance to the object to be imaged is calculated by the measurement part 33 based on this information (S502). However, in the controller on the robot arm 2 side, an estimated value of the distance from the control position of the gripping portion 2a to the object to be imaged may be calculated, and this estimated value may be transmitted to the measurement part 33 as information about the distance to the object to be imaged. In this case, the measurement part 33 may perform the process from step S503 in FIG. 14. The information, acquired by the measurement part 33, about the distance to the object to be imaged may be still other information, and, for example, the measurement part 33 may acquire the extraction range W0 in step S503 in FIG. 14 from the controller on the robot arm 2 side.

### Modification 3

In the above embodiment, as shown in FIG. 6, a plurality of search processes (first process and second process) are performed in parallel for the same search range R0. In contrast, in Modification 3, a plurality of search processes (first process and second process) for the same search range are performed at different timings, and a plurality of search processes (first process and second process) are performed for a plurality of search ranges, respectively.

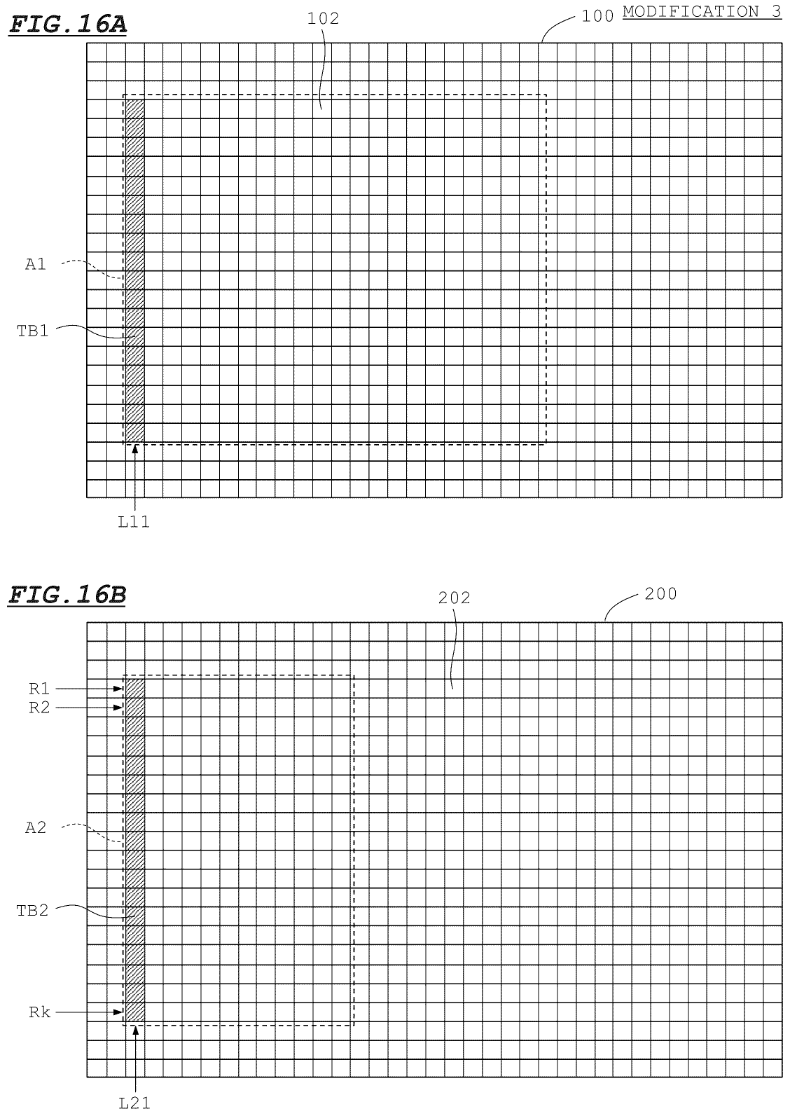

FIG. 16A is a diagram showing a method for setting target pixel blocks TB1 according to Modification 3. FIG. 16B is a diagram showing a method for setting a search area A2 according to Modification 3.

In Modification 3, a search for a matching pixel block MB2 is performed for each column in the detection region A1 in the first image 100. FIG. 16A shows a state where target pixel blocks TB1 are set for a column L11 at the head. In this case, as shown in FIG. 16B, each pixel block in a column L21 on the second image 200 at the same position as the column L11 is set as a standard pixel block TB2. Then, as in the above embodiment, search ranges R1, R2, . . . , Rk are set so as to extend from these standard pixel blocks TB2 in the right direction, and these search ranges R1, R2, . . . , Rk constitute a search area A2.

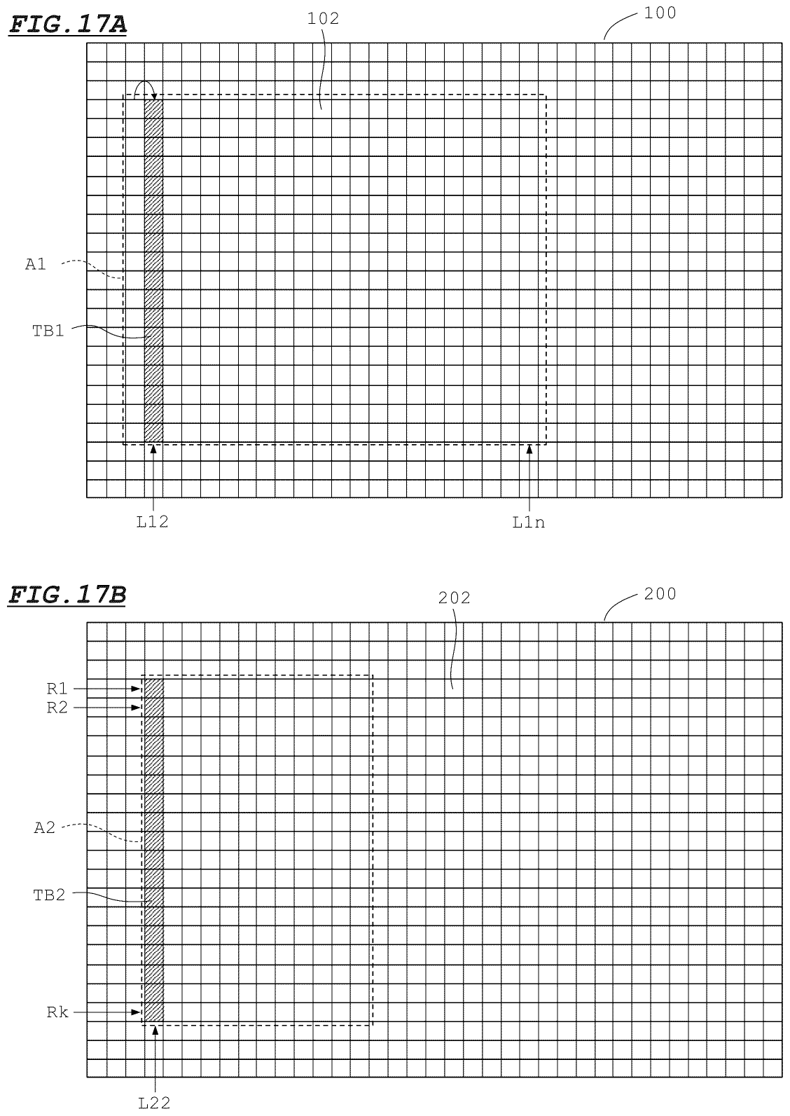

For the search ranges R1, R2, . . . , Rk in the column L21 thus set, a search for a matching pixel blocks MB2 is performed, and the distance for each target pixel block TB1 in the column L11 is acquired based on the searched matching pixel block MB2. Then, when the process for the columns L11 and L21 is completed, target pixel blocks TB1 are set for the next column L12 as shown in FIG. 17A, and each pixel block in a column L22 at the same position as the column L12 is set as a standard pixel block TB2 as shown in FIG. 17B. Then, as in the above, search ranges R1, R2, . . . , Rk extending from these standard pixel blocks TB2 in the right direction are set in the second image 200, and these search ranges R1, R2, . . . , Rk constitute a search area A2.

The same process is executed in the same manner until a final column Lin in the detection region A1. Accordingly, search and distance acquisition are performed for all the pixel blocks included in the detection region A1.

Here, as for a search process for the search area A2, as described above, a plurality of search processes (first process and second process) for the same search range are performed at different timings, and a plurality of search processes (first process and second process) are performed in parallel for a plurality of search ranges, respectively.

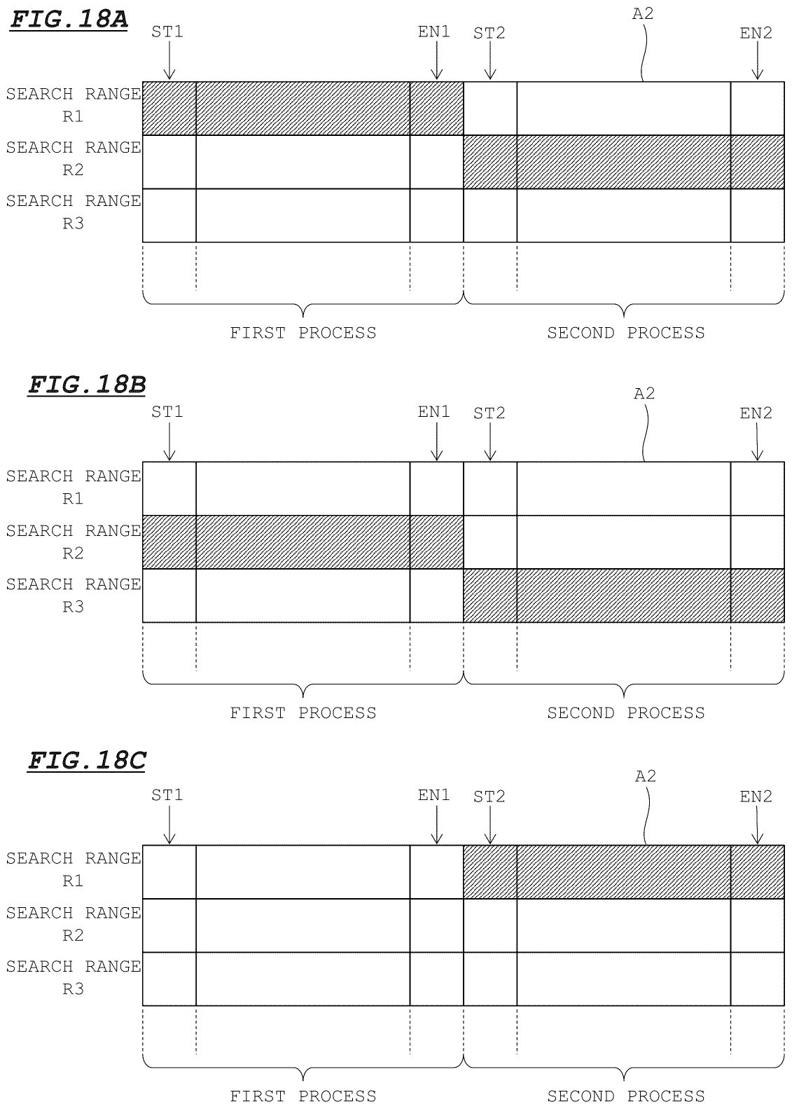

FIG. 18A to FIG. 18C are each a diagram schematically showing the search process for the search area A2 according to Modification 3. In FIG. 18A to FIG. 18C, hatching indicates ranges for which the search process is performed.

Here, as in FIG. 4, one search range is divided into two ranges, the first half and the second half. The first process is executed for the first half of the search range, and the second process is executed for the second half of the search range. Then, while the first process is executed for the first half of one search range, the second process is executed in parallel for the second half of the search range immediately below this search range.

That is, as shown in FIG. 18A, the measurement part 33 executes the first process for the topmost search range R1 and the second process for the second search range R2 from the top in parallel. After these processes are completed, the measurement part 33 executes the first process for the second search range R2 from the top and the second process for the third search range R3 from the top in parallel as shown in FIG. 18B. As described above, the measurement part 33 performs the first process and the second process sequentially in parallel while shifting the search range to be processed, by one range. While executing the first process for the bottommost search range Rk, the measurement part 33 executes the second process for the topmost search range R1 in parallel, as shown FIG. 18C. Thus, the measurement part 33 completes the search process for one search area A2.

By this process as well, a minimum correlation value by the first process and a search position therefor, and a minimum correlation value by the second process and a search position therefor are acquired for each search range. Therefore, by comparing the magnitudes of the two acquired correlation values as in FIG. 9A and FIG. 9B, the matching pixel block MB2 in each search range can be extracted. The methods of Modifications 1 and 2 may be used as the method for extracting the matching pixel block MB2.

In FIG. 18A to FIG. 18C, one search range is divided into two ranges, the first half and the second half, but as shown in FIG. 5, a range for which the first process is performed and a range for which the second process is performed may partially overlap. In addition, in FIG. 18A to FIG. 18C, the search ranges for which the first process and the second process are performed are shifted from each other by one range, but the search ranges for which the first process and the second process are performed may be shifted from each other by two or more ranges.

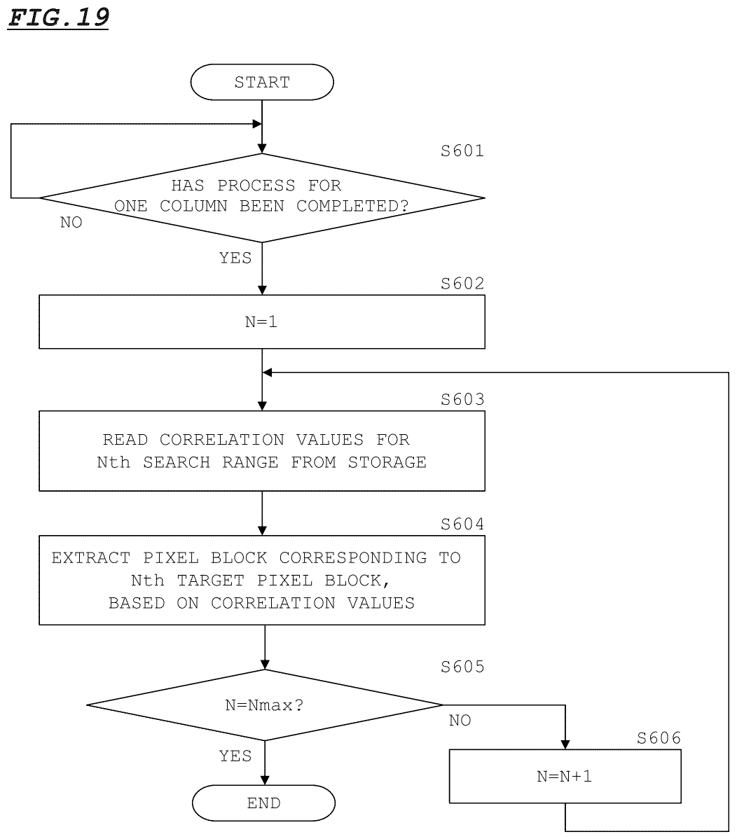

FIG. 19 is a flowchart showing an extraction process for the matching pixel block MB2 according to Modification 3.

The measurement part 33 stores the minimum correlation values and the search positions therefor acquired by the first process and the second process while performing the process for one column shown in FIG. 18A to FIG. 18C, in the output signal storage 34 in association with the search range. The method for acquiring the minimum correlation values and the search positions therefor in the first process and the second process is the same as the method shown in FIG. 7A to FIG. 7D. The measurement part 33 reads the processing results of the first process and the second process thus stored, for each search range, and executes the process in FIG. 19.

When the process for one column is completed (S601: YES), the measurement part 33 sets 1 as a variable N (S602), and reads the minimum correlation values acquired by the first process and the second process for the Nth search range from the top, from the output signal storage 34 (S603). Then, the measurement part 33 extracts the matching pixel block MB2 corresponding to the Nth target pixel block TB1 from the top in this column, based on the correlation values read from the output signal storage 34 (S604). That is, as in the above embodiment, the measurement part 33 extracts the pixel block at the search position corresponding to the lower one of the correlation values by the first process and the second process read from the output signal storage 34, as the matching pixel block MB2.

Then, when the matching pixel block MB2 corresponding to the Nth target pixel block TB1 from the top is extracted, the measurement part 33 determines whether or not the variable N has reached a maximum value Nmax of the target pixel blocks TB1 included in one column (S605). If the determination in step S605 is NO, the measurement part 33 adds 1 to the variable N (S606) and returns the process to step S603. Accordingly, the matching pixel block MB2 corresponding to the next target pixel block TB1 is extracted (S603, S604). The measurement part 33 repeats the same process until the process for the final target pixel block in this column is completed (S605: NO).

Then, when the process for the final target pixel block in this column is completed (S605: YES), the measurement part 33 ends the process for this column. Accordingly, the matching pixel blocks MB2 are extracted for all the target pixel blocks TB1 included in the column to be processed. Then, the measurement part 33 executes the process in FIG. 19 for the next column in the detection region A1. By performing the process up to the final column in the detection region A1 as described above, the matching pixel blocks MB2 are extracted for all the target pixel blocks TB1 included in the detection region A1. Then, the measurement part 33 performs the process in FIG. 10A. Accordingly, the distances for all the target pixel blocks TB1 included in the detection region A1 are calculated, and the calculated distance for each target pixel block TB1 is transmitted to an external device.

In Modification 3 as well, as in the above embodiment, a plurality of search processes (first process and second process) are performed in parallel, so that the time required to search the search range can be shorter than when the search is continuously performed for the entire search range. Therefore, the search for the target pixel block TB1 can be performed at a higher speed.

In the process in FIG. 19, the minimum correlation values and the search positions therefor acquired by the first process and the second process are stored once in the output signal storage 34 in association with the search range, but a buffer memory or the like may be provided exclusively for storing these pieces of information.

In Modifications 1 and 2 described above, since each matching pixel block MB2 is outputted from either the first process or the second process, the distance signal outputted from either the first process or the second process may be stored in the output signal storage 34 without comparing the correlation values acquired by the first process and the second process as in the process in FIG. 19. Accordingly, the distance signal can be stored in association with the target pixel block, so that the processing is reduced.

### Other Modifications

In the above embodiment and Modifications 1 to 3, one search range is divided into two ranges, and two search processes (first process and second process) are performed on the two divided ranges, respectively, but one search range may be divided into three or more ranges, and three or more search processes may be performed on the three or more divided ranges, respectively.

In the above embodiment and Modifications 1 to 3, one search range is divided into ranges each including the same number of pixel blocks, but one search range may be divided into ranges including different numbers of pixel blocks.

The length of the search range R0 is not limited to the length shown in the above embodiment, and may be set to a length corresponding to the measurement distance range.

In the flowchart in FIG. 6, each time a correlation value is acquired (S105, S110), the acquired correlation value is compared with the minimum correlation value acquired up to that time, and the minimum correlation values by the first process and the second process are extracted (in S106 and S111), but the method for acquiring the minimum correlation values is not limited thereto. For example, all correlation values acquired by the first process and the second process may be stored in the output signal storage 34 or the like, the minimum correlation value may be extracted from among these values, and the pixel block for the extracted correlation value may be extracted as the matching pixel block MB2 corresponding to the target pixel block TB1.

The use form of the stereo camera system 1 is not limited to the use form shown in FIG. 11A and FIG. 11B, and the stereo camera system 1 may be used for another system that performs predetermined control by using the distance to an object. In addition, the configuration of the stereo camera system 1 is not limited to the configuration shown in the above embodiment, and, for example, a photosensor array having a plurality of photosensors arranged in a matrix may be used as each of the imaging elements 12 and 22.

In addition to the above, various modifications can be made as appropriate to the embodiment of the present invention, without departing from the scope of the technological idea defined by the claims.

What is claimed is:

1. An image processing device comprising
a measurement part configured to process a first image outputted from a first imaging part and a second image outputted from a second imaging part placed so as to be separated from the first imaging part, and search for a pixel block corresponding to a target pixel block on the first image, in a search range defined on the second image, wherein
the search range extends in a direction of separation between the first imaging part and the second imaging part, and
the measurement part respectively executes a plurality of search processes for a plurality of ranges into which the search range is divided.

2. The image processing device according to claim 1, wherein the measurement part performs the plurality of search processes in parallel for the same search range.

3. The image processing device according to claim 1, wherein the measurement part performs the plurality of search processes for the same search range at different timings, and performs the plurality of search processes in parallel for the plurality of search ranges, respectively.

4. The image processing device according to claim 1, wherein the measurement part extracts a pixel block having a highest degree of correlation with the target pixel block, as the pixel block corresponding to the target pixel block, based on processing results of the plurality of search processes.

5. The image processing device according to claim 1, wherein the measurement part excludes a pixel block whose degree of correlation with the target pixel block does not exceed a predetermined threshold value, from an extraction target in the plurality of search processes.

6. The image processing device according to claim 4, wherein the measurement part acquires information about a distance to an object to be imaged, and selects the processing result to be a target for extraction of the pixel block, based on the acquired information.

7. An image processing method comprising
a step of processing a first image outputted from a first imaging part and a second image outputted from a second imaging part placed so as to be separated from the first imaging part, and searching for a pixel block corresponding to a target pixel block on the first image, in a search range defined on the second image, wherein
the search range extends in a direction of separation between the first imaging part and the second imaging part, and
the searching step includes a step of respectively executing a plurality of search processes for a plurality of ranges into which the search range is divided.

8. The image processing method according to claim 7, wherein, in the searching step, the plurality of search processes are performed in parallel for the same search range.

9. The image processing method according to claim 7, wherein, in the searching step, the plurality of search processes for the same search range are performed at different timings, and the plurality of search processes are performed in parallel for the plurality of search ranges, respectively.

10. The image processing method according to claim 7, wherein, in the searching step, a pixel block having a highest degree of correlation with the target pixel block is extracted as the pixel block corresponding to the target pixel block, based on processing results of the plurality of search processes.

11. The image processing method according to claim 7, wherein, in the searching step, a pixel block whose degree of correlation with the target pixel block does not exceed a predetermined threshold value is excluded from an extraction target in the plurality of search processes.

12. The image processing method according to claim 10, wherein, in the searching step, information about a distance to an object to be imaged is acquired, and the processing result to be a target for extraction of the pixel block is selected based on the acquired information.
